(19) United States
(12) Patent Application Publication
(10) Pub. No.: US 2016/0332890 A1
(43) Pub. Date: Nov. 17, 2016

(54) MOBILE DEVICE FOR FILTERING A LIQUID UNDER PRESSURE, PROVIDED WITH A CONTAINMENT ENCLOSURE FOR A FILTER

(71) Applicant: Pierre MARCONI, Shanghai (CN)

(72) Inventor: Pierre MARCONI, Shanghai (CN)

(21) Appl. No.: 15/112,416

(22) PCT Filed: Jan. 22, 2015
(86) PCT No.: PCT/EP2015/051294

§ 371 Date: Jul. 18, 2016

(30) Foreign Application Priority Data
Jan. 24, 2014 (FR) 1450634

(51) Int. Cl. C02F 1/00; B01D 36/00

(52) U.S. Cl. CPC C02F 1/003; B01D 36/001; C02F 2301/066; C02F 2307/04; B01D 2201/202

(57) ABSTRACT

The invention relates to a device (1) for filtering a liquid under pressure, provided with a containment enclosure (4) for a filter (8), containing a volume of water which varies independently of the volume of water contained in the rest of the device. Said enclosure, also called a “cage”, is suitable for allowing the containment therein of a filter (8), such that said filter is fully submerged for a suitable amount of time for the filtration cycle.

### 1. FIELD OF THE INVENTION

The field of the invention is that of filtration systems of liquid under pressure, intended in particular to be used to purify water by passing through a filter under the action of a pressurizing device.

More specifically, the invention relates to a device for filtering a liquid under pressure, provided with a containment enclosure for a filter containing a volume of water which varies independently of the volume of water contained in the rest of the device. This enclosure also called a “cage”, is adapted to allow the containment in its center of a filter, such that the aforementioned filter is fully submerged for a suitable amount of time for the filtration cycle.

The invention also relates to the method for implementing this filtering device by a user, and the use of this device for filtering the liquid.

### 2. SOLUTIONS OF THE PRIOR ART

According to figures published by WHO, one in five people in the world today could not have access to drinking water. Chemicals, infectious agents or even radioactivity are factors related to human activities that contribute to the rapid deterioration of our aqueous reserves and at the same time, to a significant increase in health risks. In this context, water treatment constitutes a prime issue to which many individuals and communities are now trying to find solutions.

The constraints to obtain consumable quality water are those related to the delivery of this resource to the place of consumption, especially in the context of an individual business activity. Specific solutions have therefore been developed for preparing mobile, compact filtration devices, which prevail themselves on high quality filtration and satisfactory performance. Because of their greater filtration speed, the devices incorporating pressurization systems are clearly stand out from conventional filtration devices.

Thus, a person skilled in the art is familiar with a certain number of filtration devices under pressure, of type of pressure filtering water decanter comprising two water reservoirs—see French patent application F 1300037 for instance. According to these devices, the first reservoir is fitted into the second so that the transfer of water from one reservoir to the other can only be made by passing through a filter in the form of a cartridge mounted vertically in the enclosure defined by the first container. The decanter is made airtight by affixing a cover in which a pressurizing device is assembled. By actuating this pressurizing device, the user injects air into the decanter, which accelerates the process of filtration of the water contained in the first reservoir.

A major drawback of this type of device is the progressive emergence of the filtering cartridge as the water level in the first container decreases. In fact, it should be noted that the filter performance directly depends on the actual volume of the submerged filter. Also, during the cycle of use of the decanter, the level of water in the first container decreases until causing partial emergence and then total of the filter, the performance of this filter decreases gradually to move towards a zero value when the first container is empty, thus affecting the overall performance of the whole device.

### 3. OBJECTIVES OF THE INVENTION

The invention aims to overcome these disadvantages of the prior art.

More precisely, the invention aims at providing a simple mobile device for filtering liquid under pressure allowing flow of a suitable amount of time during the filtration step during which the filter performance maintains maximum value.

The invention also aims at, in at least one embodiment, providing a filtration device with optimal performance.

The invention also aims at providing, in at least one embodiment a very compact filtration device which can be easily handled, operated, installed and removed by a user.

The invention also aims at providing, in at least one embodiment, a filtration device inside which may be fitted a filter in the form of a cartridge or allowing the generation of an ultrafiltration method.

The invention also aims at providing, in at least one embodiment, a filtration device inside which can be fitted an additional unit for liquid processing or distribution of specific chemical elements.

The invention also aims at providing, in at least one embodiment, a filtration device capable of providing the user with information about the filter usage time and/or chemical characteristics of the liquid which it contains.

The invention also aims to implement a liquid filtration process incorporating this filtration device.

### 4. ESSENTIAL FEATURES OF THE INVENTION

These objectives, and others that appear later are achieved by providing a device for filtering liquid comprising:
A first container intended to contain the liquid to be filtered. The walls of this first container comprising at least two openings: an inlet opening and an outlet opening,
A pressurizing device adapted to inject air into this first container through the inlet opening,
A filter,

This filtration device is characterized in that it comprises:
A containment enclosure at least partly contained in the first container. The walls of the containment enclosure include at least three distinct openings:
   a filling opening adapted to allow the passage of liquid between the first container and the containment enclosure.
This filling opening is located in the lower part of the containment enclosure,
   a purge opening, located in the upper part of the containment enclosure,
   filtration opening. This filtration opening can replace the outlet opening.
An air purging device adapted to control the plugging of the purge opening and operable to allow the purging of at least a part of the air contained in the containment enclosure.

In this invention, the device for filtering liquid is considered according to an optimal use orientation which indicates a position of the filtration device allowing its optimal operation or in other words, a position in which the total output of the filtering device during the filtering step is maximum within the limits of the technical features inherent to the structure of the device. Thus according to an initial embodiment of the invention illustrated by FIG. 1, the filtering device is positioned at an optimal use orientation when its axis of revolution is vertical. The invention is however not limited to this specific embodiment and also relates to filtration devices whose components are arranged differently in relation to each other. The term “output” as used herein refers to the volume of water that can be processed by the filter in a given amount of time under the effect of a given injection stress. For example, within the context of a filtration device wherein the pressurizing device, the first container and the whole formed by the containment enclosure and the filter are respectively aligned along the same theoretical axis (X), being interlocked to a certain extent, the optimum use orientation would be one in which the theoretical axis (X) coincides with the geocentric axis. This orientation would thus allow the system and in particular the filtered liquid to benefit to the full from gravitational force while lengthening the maximum immersion time of the filter during the cycle of use, resulting in optimal operation of the entire filtration device. Normal orientation of use may itself be defined as an orientation for the proper functioning of the filtration device without the performance of the device necessarily being maximal. Generally, all “upper” and “lower” terms as used in this invention refer to location areas with respect to a theoretically indicated horizontal plane which is roughly perpendicular to the geocentric axis, in which components of the considered device can potentially be found according to an optimal orientation of use. Thus, the terms “upper portion of the containment enclosure” and “lower portion of the containment enclosure” mean parts of the containment enclosure located respectively above and below the theoretical horizontal plane passing through the upper end of the filter, i.e. the portion of the filter having the highest vertical component.

The term “inlet opening” as used in this invention denotes an opening used during loading of the liquid to be filtered of the first container and during the injection of air into the latter via the pressurizing device.

The expression “capable of replacing the outlet opening” as used in this invention and concerning the filtration opening is reflected by the function associated with the filter opening, discharge of the liquid after filtration outside the assemble formed by the first container, the containment enclosure and the filter. Assuming a filtration device not comprising a containment enclosure, such as those described in the prior art, this evacuation function of the filtered liquid is associated with the outlet opening of the invention.

When the components of the filtration device as described above are arranged therebetween, the filtering process may then be implemented by a user according to the following steps:
The liquid to be filtered is introduced into the first container by the user, through the inlet opening. It should be noted that such a container gives the user a good autonomy of use by the ability it confers to store a given quantity of liquid to be filtered. The user therefore does not need to be near a liquid supply source to operate the device. During filling of the first container, the liquid to be filtered is potentially introduced in the containment enclosure through the filling opening, letting a portion of the air initially contained in the latter to escape into the first container.
According to a first embodiment of the invention, the purge device hermetically closes the purge opening when not in use. The user, following the first filling, then purges an additional portion of the air initially contained in the containment enclosure by actuating the purge device. The liquid in the first container to be filtered is then introduced more in the containment and increases the immersed volume of the filter. The user can then introduce an additional volume of liquid in the first container in order to compensate the volume of liquid being transferred to the containment enclosure during purging.
According to a second embodiment of the invention, the purge device, when not operating, allows the passage of an air flow between the inside and outside of the containment enclosure. The filter is then immersed during the liquid filling step of the first container, by passing the liquid through the filling opening and leveling of the fluids in the first container and in the containment enclosure respectively, according to the communicating vessels principle. A subsequent user action enables the purge device to be switched to the closed position.
The closing of the purge opening at the end of the draining step generates a differential pressure preventing the liquid contained in the containment enclosure from going into the first container again. A closed circuit thus forms between the inlet opening and the filtering opening.
By actuating the pressurizing device, the user injects air into the first container, through the inlet opening, creating at the same time an overpressure in the first container and the containment enclosure. The differential pressure created between the inlet and the outlet of the filter then allows liquid to pass through the filter, from the containment enclosure to the outside of the assembly formed by the containment enclosure, first container and filter. The operation is then repeated until the exhaustion of the liquid in the containment enclosure, state marking the end of the filtration process.

Following the filling phase of the containment enclosure, the filter is immersed to its maximum level. This immersion state remains unchanged at least until lowering of the liquid level in the first container down to the level of the filling opening. However, this filling opening is located in the lower part of the containment enclosure or in other words, below the theoretical horizontal plane passing through the upper end of the filter. Therefore, the containment enclosure allows an extension of the duration of immersion of the filter during the cycle of use. Filter output being relative to the effective volume of the submerged filter, the filter output thus retains a maximum value during a prolonged period of time of the filtration step.

According to a special feature, the purge device is located at least partly outside the first container.

This technical feature makes it possible to make the filtration device more ergonomic, the purge device is logically placed in a position easily accessible by the user. Moreover, when the operation of the purge is manual, the user is not forced to insert fingers into the first container to operate the purge device, thus limiting the risk of contamination that may occur between unfiltered water and the user's fingers.

According to a special feature, the pressurizing device comprises a cavity wherein the air purge device is at least partly included.

Thus, a portion of the purge device is integrated within the pressurizing device. This technical feature thus provides improved compactness of the filtration device, which allows easy storage in a reduced volume for purposes of storage or transport, as well as improved robustness. The purge device can potentially benefit from protection of external mechanical shocks conferred by the structure of the pressurizing device in which it is integrated.

According to a special feature of the first embodiment of the invention, a portion of the containment enclosure forms a lug on the first container through the inlet opening. The purge opening is handled carefully in this portion of the enclosure.

This technical feature improves the compactness of the filtering device. This is why the inlet opening has the additional function of allowing the emergence of a portion of the purge device outside the first container. In addition, as the purge opening is located outside the first container, the purge device attached thereto is subjected to a reduced number of technical constraints for operation, in particular in terms of sealing. The structure of the latter is therefore potentially simplified. Finally, as part of the containment chamber is made of this technical feature permanently located outside of the first container, this portion therefore defines an area filled with air throughout the filtration cycle. Assuming the part of the purge device located inside the containment enclosure is confined to this immersed area, the lack of direct contact between the liquid to be filtered and the purge device accordingly allows limit contamination. The hygiene of the whole filtering device is thereby improved.

According to a particular feature of the first embodiment of the invention, the purge device comprises a movable valve closure member associated with spring mechanisms and moving under a predetermined pressure.

According to this technical feature, the purge device is operable to regulate the flow of air between the said containment enclosure and cavity. It is materialized in the form of a non-complex and sturdy structure that is easy to use. Preferably, the pressure threshold selected as a condition for moving the movable valve closure member corresponds to the average pressure force of an adult hand. The purge device is therefore easily operable while remaining stable in the absence of special stress.

According to a special technical feature of the second embodiment of the invention, the containment enclosure includes a receptacle formed around the purge opening on the outer wall of the containment enclosure, and adapted to receive a purge, component making up the aforementioned purge device, comprising at least a part of the receptacle's additional form, as the purge is movable between at least two positions:
a closed position, wherein the purge hermetically closes the purge opening,
a purge position, wherein the purge allows an air flow between the inside and outside of the enclosure.

According to a special technical feature, the purge device adopts a purge position when not operating and thus allows an air flow between the inside and outside of the containment enclosure.

This special technical feature has the advantage of allowing a user, in a single step, to fill the containment enclosure and the first container, the air initially contained in the containment enclosure escaping through the purge opening as the step progresses.

According to a special technical feature, the purge passes from the purge position to the closed position by elastic deformation, and vice versa.

Thus, the purge device does not comprise a spring. The structure and capability of the purger to become elastically distorted are the only factors considered when determining the force necessary for switching the purger from one position to another. The purge device is therefore less complex and easier to produce, use, and keep in good condition.

According to a special technical feature, the pressurizing device comprises an actuator with a complementary shape to a part of the purger. This actuator is intended to maintain the purger in its closed position.

Thus, the assembly of the pressurizing device and the corresponding force produced by the actuator on the purger, switch the purger to the closed position. A user, after the liquid filling step of the first container and the containment enclosure, may thus close the purge opening by assembling the pressurizing device. No direct contact is therefore required between the user and the purge. Moreover, the pressurizing device, once assembled, independently keeps the purge device in the closed position.

According to a special technical feature, the actuator is secured to the purger.

Such attachment may alternatively be removable or permanent, and has the advantage of allowing the alignment of the purger along the axis of revolution of the filtration device. The zones of contact between the actuator and the purger are then constant from one use phase to another.

According to a particular feature, the containment enclosure is totally inside the first container.

This feature allows complete immersion of the containment enclosure, and therefore of the filter, after the step of filling the first container.

According to a particular feature, the containment enclosure comprises a filling valve, arranged on the filling opening, and adapted to allow unilateral flow of fluid from the first container to the inside of the containment enclosure.

According to a particular feature, the containment comprises a purge valve, arranged on the purge opening, and adapted to allow unilateral flow of a fluid from within the containment enclosure to the outside of the containment enclosure.

According to a particular feature, the containment enclosure comprises a filter cap adapted to be secured around the said outlet opening and including the filter opening.

According to a particular feature, the filter plug includes an end piece in the shape of a hollow cylinder of which a first end is mounted around the filter opening, and a second end consists of an attachment to fasten the end piece to the filter.

This type of end piece may thus contain filtering components completing the filter's filtering action. Alternatively, this end piece may be fixed so that it can be removed from the filter plug or be permanently attached to the filter plug to form a single mechanical part with the latter.

According to this technical feature, a part of the confinement enclosure is removable. It is the same for the filter attached thereto. The user can proceed with the installation and removal of the filter and part of the containment enclosure concerned, with a view to check and clean equipment, or replace parts.

According to a particular feature, the lower end of the first container is located above the lower end of the containment enclosure and the filling opening is located at the lower end of the first container.

This technical feature means maintaining the filter immersed at least until there is no more liquid in the first container. This avoids the presence of residual liquid in the first container while maximizing the total efficiency of the filtering device during the filtration step.

According to a particular feature, the pressurizing device is located entirely outside of the first container and occupies a variable volume between two positions:
a deployed position in which the volume occupied by the pressurizing device is maximal,
a folded position in which the volume occupied by the pressurizing device is minimal,

As this pressurizing equipment is located outside the first container, the introduction of foreign bodies inside the first container or pressurizing device is limited, and similarly the risk of contamination associated therewith. According to this technical feature, the pressurizing device is, in the absence of user action, in a stable position in which the volume occupied by the pressurizing device is minimal. The filtering device, when it is at rest, therefore has a maximum compactness.

According to a particular feature, the pressurizing device comprises a second container for collecting the filtered liquid.

This technical feature allows a better independence of the filtration device assembly. In fact, the user does not need to use a third container to collect the filtered water. According to some embodiments, the structure of the second container can be adapted to that of the rest of the device, so as to facilitate its attachment to the rest of the device, to limit the introduction of disease-causing agents therein and to optimize the volume occupied by the filtration device assembly.

According to a particular feature, the filtering containment enclosure, the first container, the second container and at least a part of the pressurizing device are revolution solids defined around a common axis of revolution.

According to a particular feature, the containment enclosure and/or the first container and/or the second container and/or at least a part of the pressurizing device are secured together in such a manner that they can be detached by means of nut-screw systems.

The term “nut-screw system” as used herein corresponds to a helical structure in which a threaded rod is assembled into a threaded hole by transfer along a screw.

According to this technical feature, the user can easily mount and dismount at will the various components of the filtration device for storage, transport, cleaning or replacement of these components. The screw-nut system has the advantage, in comparison with other removable fastening systems to adapt optimally to the association of revolution solids between them. The filtration device has accordingly improved resistance to mechanical impact and better sealing in relation to fluid leaks and pressure losses that may be incurred in connection with fluid transfers made during the cycle of use. According to other embodiments, screwing systems are replaced by clips or interlocking systems. These have the particular advantage of adapting to non-circular shapes. It is the elasticity of the material, which then ensures the closing and sealing.

According to a particular feature, the filter is at least partly ceramic and has a tubular shape, hollow, closed at a first end, a second end adapted to be secured to the containment enclosure.

Filtration by ceramic filter is generally extremely fine, of the order of 0.2 microns, because of the tiny pores which constitute its microstructure. The use of a ceramic filter thus helps stop microorganisms that are harmful to health such as viruses or bacteria. It is further possible to combine the ceramic filter with a conventional chemical treatment, thereby removing additional chemical components likely to be dissolved in the filtered liquid. The conformation of the “cartridge” filter will in turn maximize the filtering surface in contact with the filtered liquid, with the aim of increasing the efficiency of the filter. Using a filter impermeable to air can also be considered, so that only liquid fluids can pass through. Thus, the filtration process can remain effective in the case of a partial immersion of the filter in the liquid to be filtered. According to some embodiments, the pore size of at least one filter membrane may be between 0.1 and 0.001 microns. When the pore size of a ceramic filter is between 0.1 and 0.001 microns, it is called ultrafiltration. Unlike a conventional filter which limits the passage of large molecules while retaining them in its pore network, ultrafiltration blocks impurities entering the network, allowing only very small molecules through. These impurities can then be removed by the fluid dynamic effect in local contact with the filter or simply by cleaning. As a result, the filter efficiency and its service life are greatly increased, the risk of bacterial contamination within the filter is reduced and cleaning is made easier. However, due to the reduction of the pore size, the operation of this method requires a pressure differential between filter walls, which justifies the use of a pressurizing equipment within the framework of the invention.

According to a particular feature, the filtration device comprises at least one permeable reservoir able to contain filtering elements.

This technical feature has the advantage of allowing the diffusion of chemicals and/or the processing of liquid according to doses and/or a variable time depending on the place where the reservoir is positioned. Thus, the location of the reservoir in the bottom of the second container obtains a diffusion over a relatively long interval. Placing ceramic balls in the extension of the filter allows rapid water treatment. Finally, the position of the reservoir along the side walls of the second container, in a tubular shaped compartment for example, enables treatment over a very short interval, particularly suitable for dye diffusion and/or sporadic particles. This avoids excessive dosage of chemicals in the target liquid. According to particular embodiments, incorporating a pipette system within the device allows the addition of liquid substances in the liquid to be filtered. The pipette system may for example be attached in a removable way along the second container.

Device for filtering liquid according to any one of the preceding claims characterized in that at least one reservoir is fitted in the spout of the said filtration device.

The positioning of such a reservoir limits the contamination of the second container through the spout. It also has the advantage of allowing the use of filtering elements, or addition of flavors, brought into contact with filtered water for a short period of time.

According to a particular feature, the filtration device includes an adjustable chronological reference mark.

Thus, the chronological reference mark can for example be engraved on the periphery of the containment enclosure. A system of pivotally threaded rings related to this mark then indicates the filter change date. The user is thus informed of the filter usage time.

According to a particular feature, the filtration device comprises a pH measuring device and/or redox potential and/or concentration of dissolved solids.

Thus, depending on the element of the filtration device in which the measuring device is placed, the user is informed of the local chemical characteristics of the target liquid.

According to a particular feature, the filtration device is used for water filtration.

### 5. LIST OF FIGURES

Other features and advantages of the invention will become apparent from reading the following description of a preferred embodiment given as a simple illustrative and non-exhaustive example, and the accompanying drawings, namely:

FIG. 1—Schematic sectional view of a first embodiment of the invention,

FIG. 2—Schematic sectional view of the upper part of a first embodiment of the invention,

FIG. 3—Schematic perspective view of the upper part of a first embodiment of the invention,

FIG. 4—Schematic sectional view of the upper part of a first embodiment of the invention in the folded position,

FIG. 5—Schematic sectional view of the upper part of a first embodiment of the invention in the extended position,

FIG. 6—Schematic sectional view of the lower part of a first embodiment of the invention,

FIG. 7—Schematic sectional view of the upper part of a second embodiment of the invention,

FIG. 8—Perspective view of a containment enclosure according to a second embodiment of the invention,

FIG. 9—Perspective view of a purger according to a second embodiment of the invention,

FIG. 10—Perspective view of a portion of a pressurizing device according to a second embodiment of the invention,

FIG. 11—Perspective view of a filter end piece according to a second embodiment of the invention.

### 6.1 DESCRIPTION OF A FIRST EMBODIMENT OF THE INVENTION

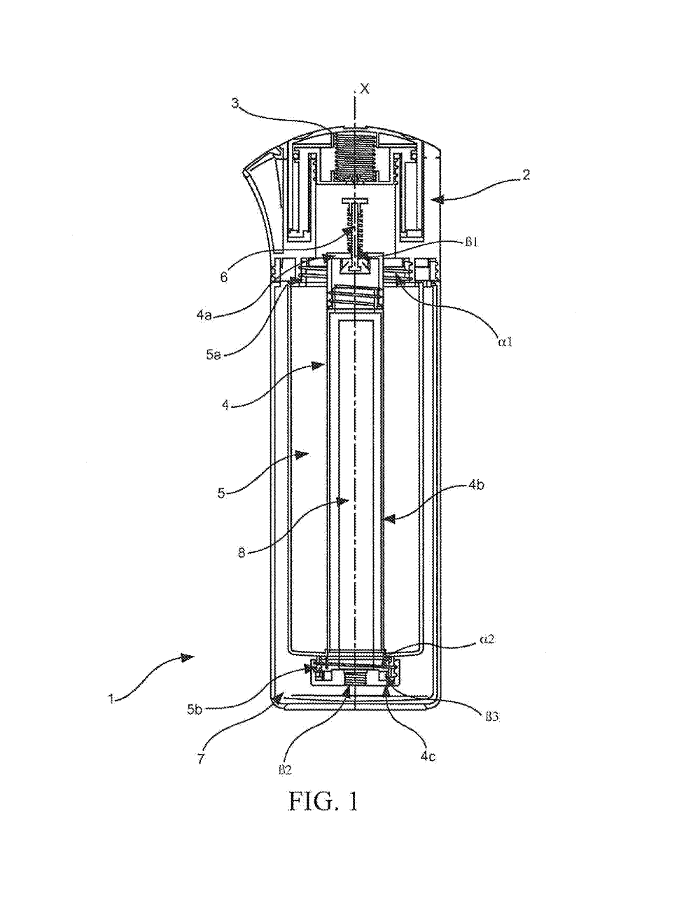

In the figures, scales and proportions are not strictly complied with, for purposes of illustration and clarity. Throughout the following detailed description with reference to the figures, unless otherwise indicated, each element of the filtration device is described as it is set up when the base of the second container is mounted horizontally. This arrangement is shown in all the FIGS. 1 to 7.

As shown in FIG. 1, the filtration device (1) according to a first embodiment includes a set of components similar to revolution solids defined with respect to a theoretical axis (X) of revolution around which they are installed. Diameters, as shown in this invention, are defined with respect to this axis (X). Thus, and as shown in FIGS. 1, 2, 4 and 5, the filtration device (1) comprises a pressurizing device (2) on its upper part consisting of a fixed portion (2a) and a removable portion (2b). The upper part of the fixed portion (2a) has the structure of a sealing ring whose axis of revolution is the theoretical axis (X) and the two lips of which are oriented upward. The upper central lip (2aa) has an inner diameter (d1), an outer diameter (d2) and a height (h1). The upper peripheral lip (2ab) has an inner diameter (d3), an outer average diameter (d4) and a height (h2). The upper central lip (2aa) comprises a screw thread (pv1) at the upper end of its inner circumference. The upper peripheral lip (2ab) includes on its periphery a pouring spout (2ac) provided with a valve (2ad). The lower part of the fixed portion (2a) has the structure of a sealing ring whose axis of revolution is the theoretical axis (X) and the two lips of which are oriented downward. The lower central lip (2ae) has an inner diameter (d5), an outer diameter (d6) and a height (h3). The lower peripheral lip (2af) has an inner diameter (d7) an average outside diameter (d8) and a height (h4). The lower central lip (2ae) comprises, at the lower end of its inner circumference, a screw thread (pv2). The lower peripheral lip (2ae) comprises at the lower end of its inner circumference a screw thread (pv3). The average outside diameter (d4) is approximately equal to the average outer diameter (d8).

The removable portion (2b) of the pressurizing device comprises a locking element (2c) and a movable element (2d). The locking element (2c) is mounted around the axis (X). The locking element (2c) has the structure of a sealing ring whose lips are directed downward. The lower central lip (2ca) has an internal diameter (d9), an outer diameter (d10) roughly equal to (d1) and a height (h5). The lower peripheral lip (2cb) has an inner diameter (d10) roughly equal to (d2), an average outside diameter (d11) and a height (h6). The lower central lip (2ca) comprises an additional screw thread (pv1) at the lower end of its outer circumference with the thread formed on the upper end of the inner periphery of the upper central lip (2aa) of the fixed part (2a). The locking element (2c) can thus be screwed in a removable way in the upper central lip (2aa) of the fixed portion (2a). The open section formed by the lower central lip (2ca) is closed at its lower end by a disc wall (2cc) apart from an air injection port (2cd) set out carefully at the center of the disc wall (2cc) which is itself sealed by a sealing ball (2ce), this ball only letting the air through from top to bottom. It should be noted that, unlike other parts of the locking element (2c), the lower peripheral lip (2cb) has a variable thickness along its circumference. In addition, the lower peripheral lip (2cb) comprises, on the lower end of its outer periphery on the thickest portion, a notch (2cf). Finally, the locking element (2c) comprises, at the upper end of the outer periphery of its lower peripheral lip (2cb), a circular rail (2cg) of height (h7).

The movable element (2d) is mounted about the axis (X). This movable element (2d) is similar to a flap plug whose upper portion (2da) has a concave shape, cavity oriented downwards. The side walls (2db) of the movable element (2d) are cylindrical, of height (h8) roughly greater than the height (h2), with an inner diameter (d12) greater than the sum of the diameter (d11) and height (h7), and an outer diameter (d13) less than the diameter (d3). The side walls (2db) of the movable element (2d) on the inner circumference of the lower end comprise a flap (2dc) ring-shaped with inner diameter (d14) greater than the diameter (d11). This flap (2dc) on its upper central end comprises a notch (2de) adapted, by its complementary shape, to fasten itself to the notch (2cf) so that it can be removed by rotating the movable element (2d) around the locking element (2c) with respect to the axis (X). Two circular lips of an inner diameter (d15) are located respectively on the lower wall of the upper part (2da) of the flap plug (2d) and the upper wall of the disc wall (2cc) of the locking element (2c) around the axis (X). A ring-shaped seal (2dd) is positioned in the circular rail (2cg), between the locking element (2c) and the movable unit (2d), the seal (2dd) only letting air through from the bottom upwards.

The assembly formed by the inner circumference of the movable unit (2d) and the upper part of the locking element (2c) defines a cavity (C1) of volume (VI).

A tension spring (3) of diameter (d16) appreciably smaller than the diameter (d15), is positioned around the axis (X) between the lower wall of the upper part (2da) of the flap plug (2dc) and upper wall of the disc wall (2cc) of the locking element (2c). This tension spring (3) is in particular maintained in the axis (X) by the said circular lips. When the notches (2cf) and (2de) are dissociated from each other, the tension spring (3) tends to move the movable element (2d) along the axis (X), from bottom to top, so that the flap (2dc) stops against the lower circular rail (2cg). The removable portion (2b) of the pressurizing device is then in the extended position. By exerting a given pressure on the plug, along the axis (X), from the top down, the user can force the movable element (2d) in a downward movement until the flap (2c) is roughly at the lower end of the lower peripheral lip (2cb) of the locking element (2c). The removable portion (2b) of the pressurizing device is then in the folded position. The user can then stabilize the movable element (2d) in this folded position by performing a rotation of the latter about the axis (X) so that the notches (2cf) and (2de) lock with each other, by their complementary shapes.

As represented by FIGS. 1 to 5, a confinement enclosure (4) is fixed on the lower part of the pressurizing device (2). This containment enclosure (4) is a revolution solid defined and positioned around the axis (X). The upper part (4a) of the containment enclosure (4) comprises a distal surface (4aa) of a diameter (d17) having at its center a purge opening (β1) with a diameter (d18), surmounted by a circular lip (4ab) oriented upwards. The upper part (4a) of the containment enclosure (4) is roughly coplanar with the lower part of the fixed part (2a) of the pressurizing device, and is permanently secured thereto by means of solid strips (4ac). The lower part of the upper part (4a) of the containment enclosure (4) has the structure of a sealing ring comprising a lower central lip (4ad) of average diameter (d18) and height (h9) and a peripheral lower lip (4ae) with a diameter roughly equal to (d17) and a height (h10). The lower end of inner periphery of the lower peripheral lip (4ae) comprises a screw thread (pv4).

When the removable portion (2b) of the pressurizing device (2) is screwed into its fixed part (2a), the unit formed by the disc wall (2cc) above, the inner periphery of the upper central lip (2aa) on the sides and the upper part (4a) of the containment enclosure (4) below defines a cavity (C2) with a volume (V2).

The side portion (4b) of the confinement enclosure is a cylinder of revolution defined and positioned around the axis (X). This side portion (4b) is characterized by a diameter (d19) roughly equal to the diameter (d17), a thickness (e1) and a height (h11). This side portion (4b) comprises a thread at the upper end of its inner circumference by which it is fastened by screwing into the lower peripheral lip (4ae).

The filtration device (1) further comprises a first container (5) of cylindrical shape defined and positioned around the axis (X). The first container (5) is characterized by a volume (V3), a height (h 12) and thickness (e2). It comprises a circular lip (5a) at its upper end centered around the axis (X) directed upwards, of a height (h13) roughly equal to the height (h3) which defines an inlet opening (a1) of distal shape and a diameter (d20). The upper end of the outer periphery of the circular lip (5a), diameter (d21) roughly equal to the diameter (d5) comprises a thread by which it is fastened by screwing into the lower central lip (2ae). The first container (5) also comprises at its lower end a lower circular lip (5b) centered around the axis (X), pointing downwards, of height (h14), which defines a outlet opening (a2) of distal shape and a diameter (d22). The lower end of outer periphery of this lower circular lip (5b), of diameter (d23) comprises a screw thread (pv5).

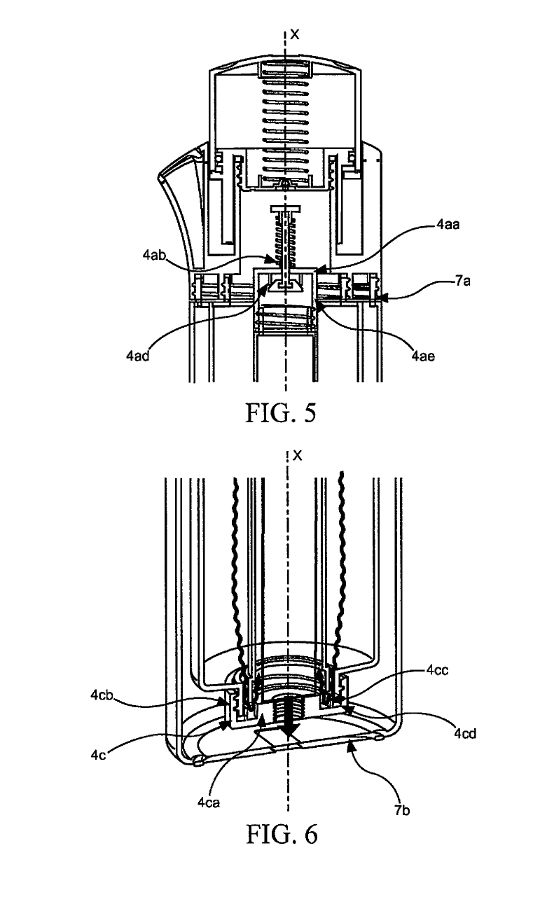

As shown in FIGS. 1 and 6, the lower portion (4c) of the containment enclosure is similar to a sealing ring whose axis of revolution is the theoretical axis (X) and the two lips are oriented towards the top. The upper central lip (4ca) has an internal diameter (d24), an outer diameter (d25) and a height (h15). The upper peripheral lip (4cb) has an internal diameter (d26), roughly equal to the diameter (d23), an outer diameter (d27) and a height (h16). The upper peripheral lip (4ca) comprises a screw thread at the upper end of its inner circumference roughly equal to the screw thread (pv5), which allows the user to screw the lower portion (4c) of the containment enclosure on the lower end of the lower lip of the first container (5). The inner periphery of the upper central lip (4ca) comprises a pv6 screw thread and defines a filter opening (β2). The lower portion (4c) of the containment enclosure includes a further reinforcing lip (4cc), of outer diameter roughly equal to the difference of the diameter (d26) by the thickness (e2), which reinforces the strength and the sealing of the detachable screw-on connection between the bottom part (4c) of the containment enclosure and the first container (5). A sealing ring (4cd) is positioned in the extension of the lower end of the lower circular lip (5b), between the latter and the lower part (4c) of the containment enclosure (4). A circular filling opening (β3) is in fact formed in the space between the lower end of the side portion (4b) of the containment enclosure (4) and its lower portion (4c).

As shown in FIGS. 1 to 5, the filtration device (1) also comprises a purge device (6). This purge device (6) comprises a rod (6a), of height (h17) and diameter (d28) roughly smaller than the diameter (d18). This rod (6a) is positioned along the axis (X) in the purge opening (β1) according to a sliding pivot type connection. At its lower end, located in the containment enclosure (4), this rod (6a) comprises a concave valve closure member (6b), cavity facing downwards, and of diameter d29 higher than or equal to the diameter (d18). At its upper end, located in the cavity (C), this rod (6a) comprises a disc-shaped push button (6c) of diameter (d30) greater than (d18) centered around the axis (X). A tension spring (6d) of diameter (d31) smaller than the diameter (d30), is positioned around the axis (X) between the lower part of the push button (6c) and the upper part of the upper portion (4a) of the containment enclosure (4). This tension spring (6d) tends to move the purge device (6) along the axis (X), from bottom to top, so that the valve closure member (6b) stops against the lower end of the central lower lip (4ad) of the containment enclosure. The purge device is then in a stable position. By exerting a given pressure on the push button (6c) along the axis (X), from the top down, the user may force the purge device to move downward. The valve closure member (6b) then releases an air flow between the interior of the cavity defined by the lower central lip (4ad) and the rest of the containment enclosure (4). The space spared between the stem (6a) and the inner periphery of the circular lip (4ab) allows the flow of air between the interior of the containment enclosure (4) and the cavity (C).

The filtration device (1) also comprises a tubular-shaped ceramic filter (8), hollow, closed at a first end, a second end comprising a thread to seal the filter opening (β2). The filter (8) is intended for the filtration of water, with an average capacity of 5,000 liters, depending on the quality of the water to be filtered and the filter cleaning frequency (8). In the description of the filtration process below, the target liquid is water. However, according to other embodiments, water is replaced by another liquid and the filter is adjusted accordingly.

The filtration device further comprises a second container (7) of cylindrical shape defined and positioned around the axis (X). This second container (7) is characterized by a volume (V4), a height (h17) and a thickness (e3). It comprises at its upper end a circular lip (7a) centered around the axis (X) directed upwards, height (h18). The upper end of the outer periphery of the circular lip (7a) of diameter (d32) roughly equal to the diameter (d7) comprises a thread to which it is fastened by screwing into the lower peripheral lip (2af). The second container (7) consists of a planar surface (7b) at its lower end comprising of a non-slip surface on its lower part. This planar surface (7b) thus allows stable positioning of the filtration device (1) on a table or any other planar surface. An exhaust duct (2ag) is provided between the cavity defined by the pouring spout (2ac) and the second container (7), so as to allow drainage of the filtered liquid from the filtration device (1) when the user tilts it.

The various operating phases of the filtration device (1) are described below in their chronological order of use.

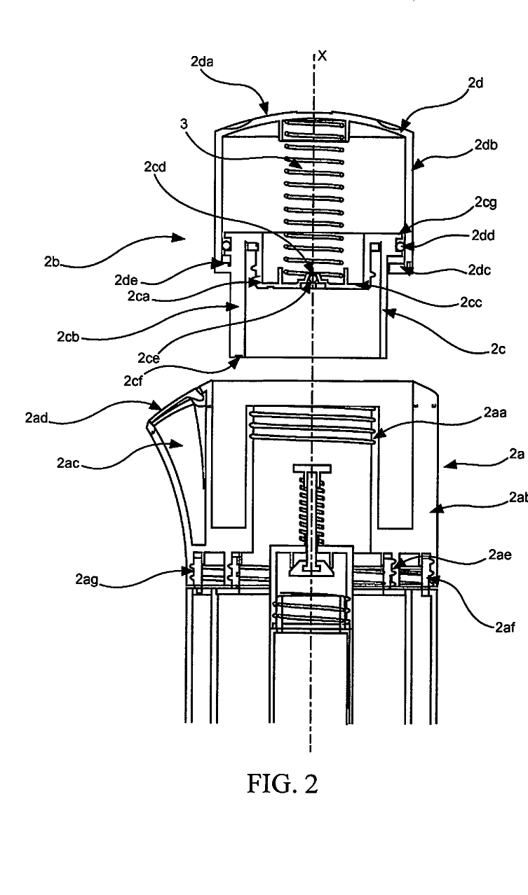

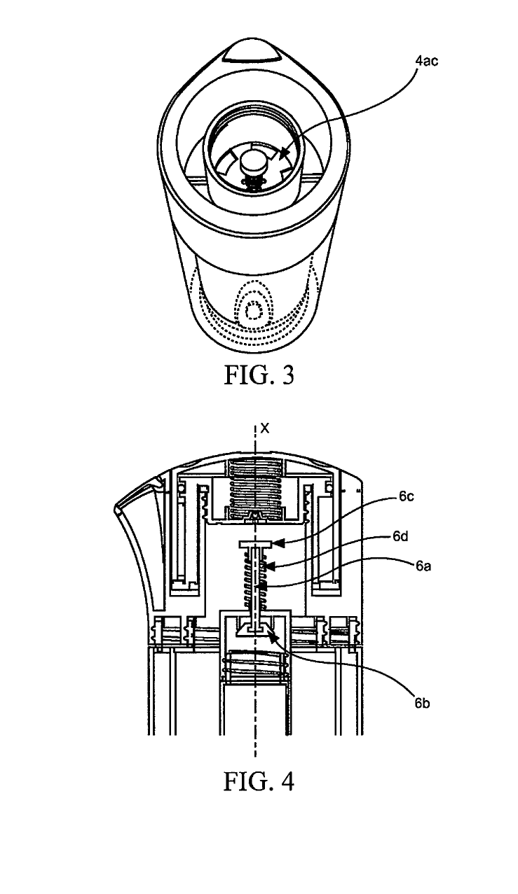

During the water loading phase and as shown in FIGS. 2 and 3, the removable portion (2b) of the pressurizing device (2) is separated from the fixed part (2a) so as to allow access to the first container (5) through the cavity (C) and the inlet opening (α1).

According to other embodiments, the pressurizing device (2) may also include, in its center, a conduit through which the user feeds the first container (5) with liquid to be filtered. According to other embodiments, this conduit can also be an annex to the pressurizing device (2).

The user fills the first container (5) with water. Once the first container (5) is filled with water, the user proceeds with purging the containment enclosure (4) by pressing the push button (6c). Air trapped in the containment enclosure (4) can then be drained through the purge opening (β1). According to the principle of communicating vessels, a portion of the water contained in the first container (5) then passes into the containment enclosure (4) through the filling opening (β3), until levels of water contained in the first container (5) and the containment enclosure (4) are roughly coplanar. The user then terminates purging by releasing the pressure exerted on the push button (6c). Under the action of the tension spring (6d), the aforementioned purge device then returns to a stable position in which the sealing of the central lower lip (4ad) by the valve closure member (6b) prevents any passage of air. The pressure differential existing then inside the containment enclosure (4) prevents any return of the water contained in the containment enclosure (4) to the first container (5). The filter present in the containment enclosure (4) is forced to remain totally submerged in the containment enclosure (4) until the water level contained in the first container (5) is lowered during the filtering phase causing the release of a part of the filling opening (β3).

Once purging is complete, the removable portion (2b) of the pressurizing device (2) is rearranged on the remainder of the device by screwing, as shown by FIGS. 1, 4 and 5.

Once the pressurizing device is assembled, we start from the premise that it is in the folded position. If this is not the case, the release phase of the movable element (2d) described below proves to be unnecessary.

During the movable element release phase (2d), the user exerts a given pressure on the plug (6da) along the axis (X), from the top down, while performing a movement of rotation relative to the axis (X) so that the notches (2cf), and (2de) separate from each other. Under the action of the tension spring (3), the movable element (2d) then moves along the axis (X), from bottom to top. The volume (VI) of the cavity (C) increases proportionally to the distance (D) separating the bottom wall of the upper part (2da) of the flap plug and the top wall of the disc wall (2cc) of the locking element (2c), generating a pressure differential between the inside and outside of the cavity (C1) which in turn causes movement of the seal (2dd) allowing the release of air flow between the circular rail (2cg) and the flap plug. This release thus allows the flow of air from outside the filtration device (1) to the cavity (C1), firstly by passing between the inner periphery of the upper peripheral lip (2ab) and the outer periphery of the side walls (2db) of the movable element (2d), followed by flow between the outer periphery of the lower peripheral lip (2cb) and the inner periphery of the flap (2dc) and side walls (2db) of the mobile element (2d). Once the pressurizing device (2) is in the extended position, as shown by FIG. 5, the differential pressure is reduced causing the closure of the air passage by return to a stable position of the seal (2dd).

During the filtration phase, the user generates a compressive force on the plug (6da), and tends to bring the lower wall of the upper part (2da) of the flap plug closer to the upper wall of the disc wall (2cc) of the locking element (2c) by transfer along the axis (X). This work is in opposition to the tension spring (3). The volume (VI) of the cavity (C) decreases proportionally to the distance (D), generating a pressure differential between the inside and outside of the cavity (C1) which in turn leads to the opening of the air injection port (2cd) by moving the sealing ball (2ce), and the transfer of air from cavity (C) to cavity (C2) and then to the first container (5).

The air supply in the first container (5) generates a pressure differential between the unit formed by the first container (5) and the containment enclosure (4), and the second container (7), which generates water transfer, from the containment enclosure (4) to the second container (7) through the filter (8). Once the pressurizing device (2) is in the folded position, the pressure differential is reduced causing the closure of the air injection port (2cd) by moving the sealing ball (2ce) towards its stable position. The transfer of water from the containment enclosure (4) to the second container (7) continues until the value of the pressure differential between the two vessels reaches a limit value, depending on filter characteristics (8), stopping the filtration process. After the air injection process, the movable element (2d) returns under the action of the tension spring (3) in extended position, filling the cavity (C1) with air at the same time. The user can then proceed to a new phase of injection of air and associated water filtration by acting on the pressurizing device (2). This process can be repeated until exhaustion of all water contained in the containment enclosure (4) and thus total immersion of the filter (8). It is then up to the user to empty the second container (7) by tilting the filtration device (1) so as to discharge the water filtered by the discharge pipe (2ag) and the pouring spout (2ac), the valve (2ad) opening by itself under the action of the discharged water.

The majority of the filtration device (1) components is attached in a removable way. Therefore, the filtration device (1) can be assembled and disassembled as the user so desires. Thus, the disassembly procedure of the lower part of the device comprises several stages, namely:
Unscrewing of the second container (7),
Unscrewing of the lower portion (4c) of the containment enclosure (4),
Unscrewing of the filter (8) of this lower portion (4c),
Unscrewing of the first container (5),
Unscrewing of the side portion (4b) of the containment enclosure (4).

The assembly process consists in screwing successively all of these components on the lower portion of the pressurizing device (2) in the reverse order of the disassembly procedure.

### 6.2 DESCRIPTION OF A SECOND EMBODIMENT OF THE INVENTION

The filtration device according to a second embodiment has many technical features in common with the filtration device according to a first embodiment described above. As such, the description of the filtration device according to a second embodiment focuses on existing technical differences between the two devices, so as to enable a person skilled in the arts to change directly and unambiguously the first device to obtain the second.

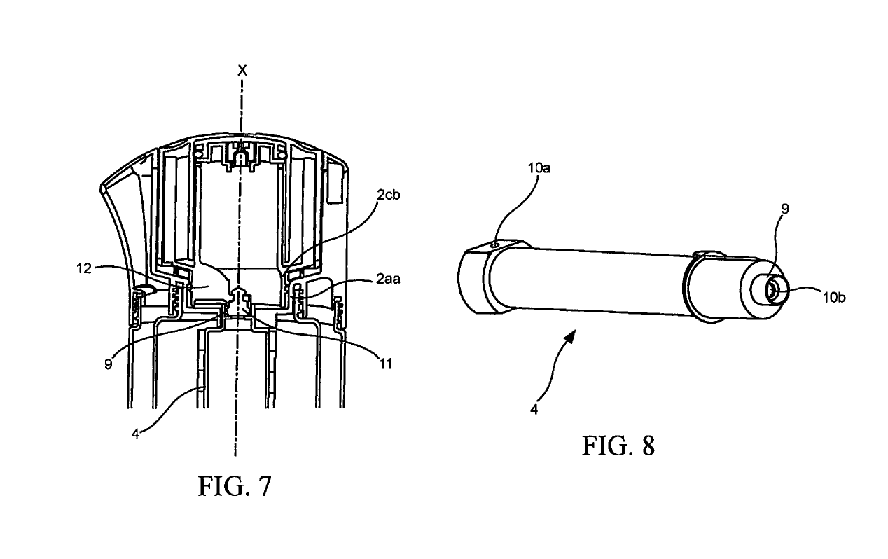

As illustrated by FIGS. 7 and 8, a filtering device (1) according to a second embodiment of the invention comprises a confinement enclosure (4) in the shape of revolution solid defined about the axis (X). This confinement enclosure (4) comprises on its upper part a purge opening surmounted with a lip forming a receptacle (9). A purge valve (10b) is arranged on the purge opening so as to allow only a unilateral flow of air from the inside to the outside of the containment enclosure.

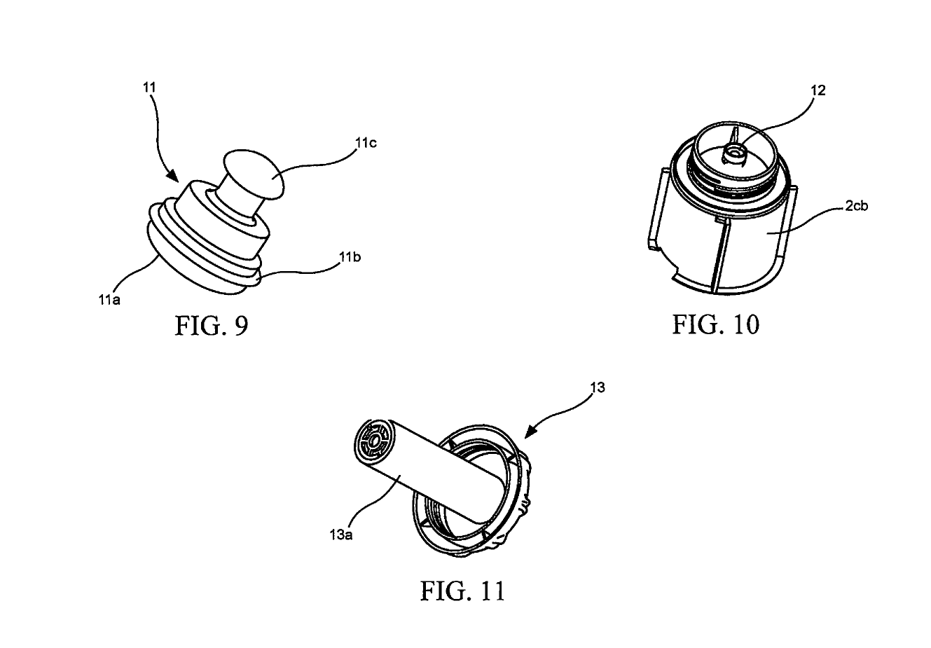

A purger (11) is mounted on the receptacle (9). This purger (11) is illustrated in FIG. 9. It is composed of a malleable elastic material such as rubber. The lower part (11a) has a complementary circular shape to the receptacle (9) and a buoy (11b) formed on its periphery. The purge includes a block (11c) in its upper part with enlarged head. In the absence of external stress, the purger (11) is mounted on the receptacle in the purging position. The buoy (11a) thus prevents the insertion of the lower portion (11a) of the unit into the receptacle (9). In contrast, when a force exceeding a predetermined threshold is applied downward on the head of the block (11c), the stresses at the buoy (11a) generate elastic deformation of the purger (11) and its insertion into the receptacle (9).

The fixed portion (2a) of a pressurizing device (2) according to this second embodiment of the invention differs such that the central lip (2aa) extends downward within the first container. The removable portion (2b) differs such that its lower peripheral lip (2cb), illustrated in FIG. 10, extends downwards and forms a screw thread with the central lip (2aa), near its lower end. This peripheral lower lip (2cb) also comprises an actuator (12) near its lower end, a part of which is centered along the axis (X) and whose shape is complementary to the block (11c) of the purger (11). Thus, when the removable part (2b) is arranged on the fixed part (2a) of the pressurizing device, the actuator (12) is arranged on the block (11c) and exerts high pressure on the bottom of the purger (11) which keeps it in the closed position.

The lower part of the containment enclosure, shown in FIG. 11, is a filter plug (13a) whose lower part is similar to a sealing ring whose axis of revolution is the theoretical axis (X) and of which the two outer lips are face upward to allow attachment of the plug (13) around the outlet opening.

This filter plug (13a) comprises a hollow cylinder-shaped end piece (13a) defined around the axis (X) of which a first end is mounted around the filter opening, and a second end comprises a fastener to enable its attachment to the lower part of the filter (8). This type of end piece may thus contain filtering components, such as a mixture of nano particles, to complete the filtering action of the filter. The lower end of the side wall of the containment enclosure (4) is secured to the filter plug (13a) via a thread.

The filtration process implemented as part of a filtration device according to the second embodiment differs from that described above in terms of the step for filling the first container with liquid to be filtered. In fact, the purger (11), while in the purging position, allows free passage of an air flow from inside to outside of the containment enclosure (4). Filling the first container thus allows complete filling of the containment enclosure (4), via the filling valve (10a) according to the communicating vessels principle. Thus the user need not carry out an intermediate purging of the containment enclosure during the filling step. Thereafter, the assembly of the removable part (2b) of the pressurizing device (2) on its fixed portion (2a) keeps the purger (11) in the closed position.

The filtration process can then continue as detailed in the description of the first embodiment of the invention.

1. Device (1) for filtering liquid comprising:
A first container (5) intended to contain the liquid to be filtered, the walls of said first container (5) comprising at least two openings: an inlet opening (α1) and an outlet opening (α2),
A pressurizing device (2) capable of injecting air into the first container (5) through the inlet opening (α1),
A filter,
Characterized in that it comprises:
A confinement enclosure (4) included at least partially in the first container (5), the walls of the containment enclosure (4) comprising at least three distinct openings: a filling opening (β3) adapted to allow the flow of a liquid between the first container (5) and the containment enclosure (4) and located in the lower portion of the containment enclosure (4), a purge opening (β1) located in the upper part of the containment enclosure (4), and a filter opening (β2) adapted to replace the outlet opening.
A purge device (6) for at least part of the air contained in the enclosure, adapted to regulate the sealing of the purge opening (β1).

2. Device (1) for filtering liquid according to claim 1, wherein the purge device (6) is located at least partly outside the first container (5).

3. Device (1) for filtering liquid according to claim 2, wherein the pressurizing device (2) comprises a cavity in which the purge device (6) of air is at least partially included.

4. Device (1) for filtering liquid according to claim 1, wherein the containment enclosure (4) comprises a receptacle (9) formed around the purge opening (β1) on the outer wall of the containment enclosure (4), and adapted to house a purger (11), element composing purge device (6), comprising at least a part of complementary shape to the receptacle (9), the purger (11) being able to move between at least two positions:
A closed position, wherein the purger (11) hermetically closes the purge opening (β1)
A purge position, wherein the purger (11) allows an airflow between the interior of the enclosure (4) and the exterior of the enclosure (4).

5. Device (1) for filtering liquid according to claim 4, wherein the purger (11) switches from the purge position to the closed position by elastic deformation, and vice versa.

6. Device (1) for filtering liquid according to claim 5, wherein the pressurizing device (2) comprises an actuator (12) of complementary shape to a part of the purger (11), the actuator (12) being intended to maintain the purger (11) in the closed position.

7. Device (1) for filtering liquid according to claim 4, wherein the actuator (12) is secured to the purger (11).

8. Device (1) for filtering liquid according to claim 1, wherein the containment enclosure (4) is fully housed within the first container (5).

9. Device (1) for filtering liquid according to claim 1, wherein the containment enclosure (4) comprises a filter plug (13) adapted to be attached around the outlet opening (α2) and comprising the filter opening (β2).

10. Device (1) for filtering liquid according to claim 1, wherein the lower end of the first container (5) is located above the lower end of the containment enclosure (4), and wherein the filling opening (β3) is located at the lower end of first container (5).

11. Device (1) for filtering liquid according to claim 1, wherein it comprises a second container (7) for collecting the filtered liquid.

12. Device (1) for filtering liquid according to claim 1, wherein the filter (8) is at least partly ceramic and has a hollow, tubular shape, closed at a first end, a second end adapted to be attached to the containment enclosure.

13. Device (1) for filtering liquid according to claim 1, wherein it comprises at least one permeable reservoir adapted to contain the filter elements.

14. Device (1) for filtering liquid according to claim 13, wherein the at least one permeable reservoir is fitted at the pouring spout of the filtering device.

15. Use of a device (1) for filtering liquid according to claim 1 for water filtration.
